(19) United States
(12) Patent Application Publication
(10) Pub. No.: US 2026/0045581 A1
(43) Pub. Date: Feb. 12, 2026

(54) METHOD FOR MANUFACTURING ENERGY STORAGE DEVICE AND ENERGY STORAGE DEVICE

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/092,102

(22) Filed: Mar. 27, 2025

(30) Foreign Application Priority Data
Aug. 7, 2024 (JP) 2024-130998

(51) Int. Cl. H01M 10/6554; B23K 20/12; B23K 101/36; B23K 103/10; H01M 10/613; H01M 10/6556; H01M 10/658; H01M 50/224

(52) U.S. Cl. CPC H01M 10/6554; B23K 20/122; B23K 20/129; H01M 10/613; H01M 10/6556; H01M 10/658; H01M 50/224; B23K 2101/36; B23K 2103/10

(57) ABSTRACT

A method for manufacturing an energy storage device according to the present disclosure is a method for manufacturing an energy storage device including a frame that houses an electrical device including a battery module, and a cooler fixed to the frame. The method includes: disposing a heat insulating member made of an aluminum alloy between a frame made of an aluminum alloy and a cooler made of an aluminum alloy such that the heat insulating member does not overlap the electrical device as viewed in the up-down direction of the energy storage device; and joining the frame and the cooler with the heat insulating member therebetween. The frame, the heat insulating member, the cooler are joined by friction stir welding.

### CROSS-REFERENCE TO RELATED APPLICATION

This application claims priority to Japanese Patent Application No. 2024-130998 filed on Aug. 7, 2024. The disclosure of the above-identified application, including the specification, drawings, and claims, is incorporated by reference herein in its entirety.

### BACKGROUND

### 1. Technical Field

The present disclosure relates to methods for manufacturing an energy storage device and energy storage devices. For example, the present disclosure relates to a method for manufacturing an energy storage device including a frame that houses a battery module, and a cooler fixed to the frame, and such an energy storage device.

### 2. Description of Related Art

An energy storage device is equipped with, for example, a cooler to cool a battery module. For example, in an energy storage device of US Unexamined Patent Application Publication No. 2023/0100022, a cooler is joined to the lower end of a frame that houses a battery module.

### SUMMARY

The present applicant found the following issue. In the energy storage device of US Unexamined Patent Application Publication No. 2023/0100022, the cooler is directly joined to the frame. Therefore, cooling energy of the cooler is absorbed by the frame. For example, the battery module etc. inside the energy storage device may not be able to be satisfactorily cooled by the cooler.

The present disclosure was made in view of such an issue, and implements a method for manufacturing an energy storage device that can satisfactorily cool a battery module etc. inside the energy storage device with a cooler, and such an energy storage device.

A method for manufacturing an energy storage device according to an aspect of the present disclosure is a method for manufacturing an energy storage device including a frame that houses an electrical device including a battery module, and a cooler fixed to the frame. The method includes:

disposing a heat insulating member made of an aluminum alloy between the frame made of an aluminum alloy and the cooler made of an aluminum alloy in such a manner that the heat insulating member does not overlap the electrical device as viewed in an up-down direction of the energy storage device; and
joining the frame and the cooler with the heat insulating member interposed between the frame and the cooler.
The frame, the heat insulating member, and the cooler are joined by friction stir welding.

An energy storage device according to an aspect of the present disclosure is an energy storage device including:

a frame that houses an electrical device including a battery module; and a cooler fixed to the frame.
A heat insulating member is disposed between the frame and the cooler so as not to overlap the electrical device as viewed in an up-down direction of the energy storage device.

In the above energy storage device, the frame may be made of an aluminum alloy, and

the heat insulating member may have lower thermal conductivity than thermal conductivity of the aluminum alloy forming the frame.

In the above energy storage device, the thermal conductivity of the heat insulating member may be lower than the thermal conductivity of A6061 aluminum alloy.

In the above energy storage device, the frame may include a frame portion with its top and bottom open,

the cooler may cover a lower opening of the frame, and
the cooler and the frame may form a case that houses the electrical device.

The present disclosure can implement a method for manufacturing an energy storage device that can satisfactorily cool a battery module etc. inside the energy storage device with a cooler, and such an energy storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified exploded view of an energy storage device according to an embodiment;

FIG. 2 is a partial cross-sectional view illustrating an arrangement relationship between a frame of a case, a heat insulating member, and a cooler in the energy storage device according to the embodiment;

FIG. 3 is a partial cross-sectional view showing a state in which the end on the − side of the Z-axis of the frame and the peripheral edge of the cooler are joined to each other via the heat insulating member in the energy storage device according to the embodiment; and

FIG. 4 is a cross-sectional view illustrating a positional relationship between a frame of a case and a cooler in the energy storage device of the comparative example.

### DETAILED DESCRIPTION OF EMBODIMENTS

Hereinafter, specific embodiments to which the present disclosure is applied will be described in detail with reference to the drawings. However, the present disclosure is not limited to the following embodiments. Also, for clarity of explanation, the following description and the drawings are simplified as appropriate.

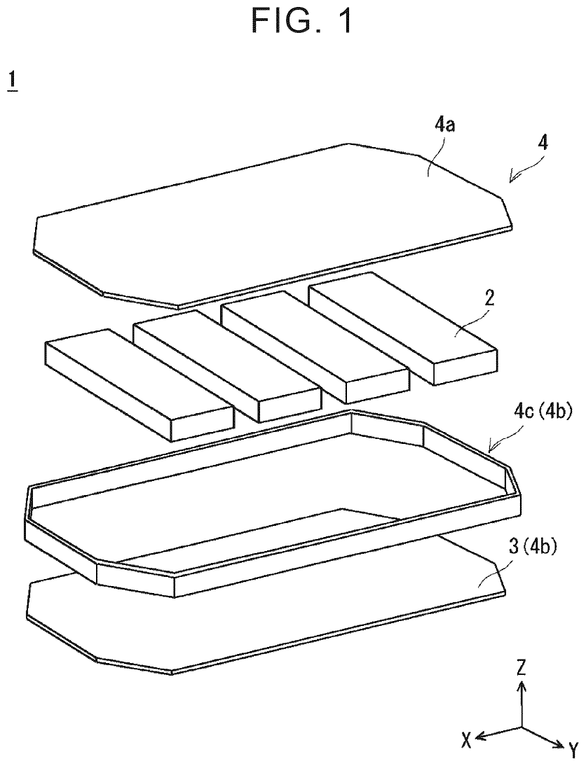

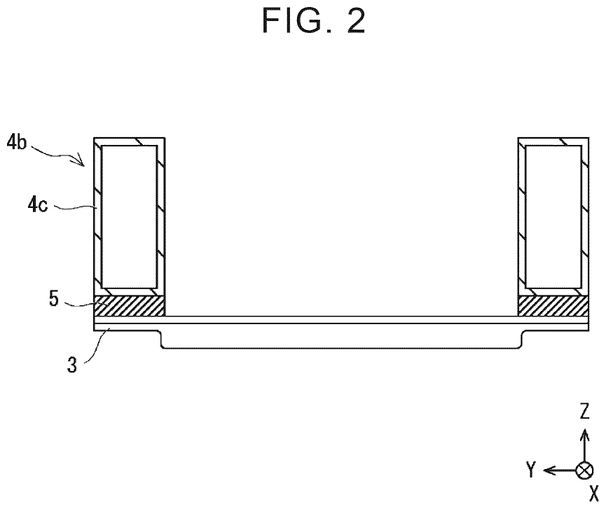

First, the configuration of the energy storage device of the present embodiment will be described. FIG. 1 is a simplified exploded view of an energy storage device according to an embodiment of the present disclosure. FIG. 2 is a partial cross-sectional view showing the arrangement relationship between the frame of the case, the heat insulating member, and the cooler in the energy storage device of the present embodiment. In FIG. 1, since the energy storage device is illustrated in a simplified manner, the heat insulating member is omitted.

In the following description, for clarity of description, a three-dimensional (XYZ) coordinate system will be used. At this time, for example, the + side of the X-axis is the front side of the energy storage device, the − side of the X-axis is the rear side of the energy storage device, the + side of the Y-axis is the left side of the energy storage device, the − side of the Y-axis is the right side of the energy storage device, the + side of the Z-axis is the upper side of the energy storage device, and the − side of the Z-axis is the lower side of the energy storage device.

The energy storage device 1 is suitable, for example, as an energy storage device mounted in a vehicle, an energy storage system, etc. As illustrated in FIGS. 1 and 2, the energy storage device 1 includes, for example, a battery module 2, a cooler 3, a case 4, and a heat insulating member 5.

The battery module 2 includes, for example, battery cells stacked in the Y-axis direction electrically connected to each other. For example, as shown in FIG. 1, the battery modules 2 are arranged at intervals in the X-axis direction. The battery module 2 is not limited to a lithium-ion battery, and may be a nickel metal hydride battery, a nickel-cadmium battery, an all-solid-state battery, or the like.

The cooler 3 is substantially in the form of, for example, a flat plate as shown in FIGS. 1 and 2, and has a configuration in which a flow passage through which a cooling medium (e.g., coolant) flows is formed inside the cooler 3. The cooler 3 can be formed by, for example, butting and joining two plates. The cooler 3 can be made of, for example, A3003 aluminum alloy.

The case 4 includes, for example, an upper case 4a and a lower case 4b as shown in FIG. 1. The upper case 4a covers, for example, the opening on the + side of the Z-axis of the lower case 4b. The lower case 4b includes, for example, a frame 4c and a cooler 3.

For example, as shown in FIG. 1, the frame 4c includes a frame portion that can house the battery module 2, and can be made of an aluminum alloy such as A6061 aluminum alloy. At this time, the frame 4c may be, for example, a hollow-rectangular extruded product or a die-cast product as shown in FIG. 2.

Thus, the energy storage device 1 can be reduced in weight. A peripheral edge of the upper case 4a is fixed to the end on the + side of the Z-axis of the frame 4c. The cooler 3 covers the opening on the − side of the Z-axis of the frame 4c. The battery module 2 is housed in the case 4.

As shown in FIG. 2, the heat insulating member 5 is disposed between the end on the − side of the Z-axis of the frame 4c and the peripheral edge of the cooler 3. That is, the heat insulating member 5 is disposed so as not to overlap the battery module 2 as viewed in the Z-axis direction. The heat insulating member 5 can be formed of, for example, an aluminum alloy such as A380 aluminum alloy having lower thermal conductivity than thermal conductivity of the aluminum alloy forming the case 4.

The end on the − side of the Z-axis of the frame 4c and the peripheral edge of the cooler 3 are joined to each other via the heat insulating member 5. This reduces absorption of cooling energy of the cooler 3 by the frame 4c, so that the battery module 2 can be satisfactorily cooled by the cooler 3.

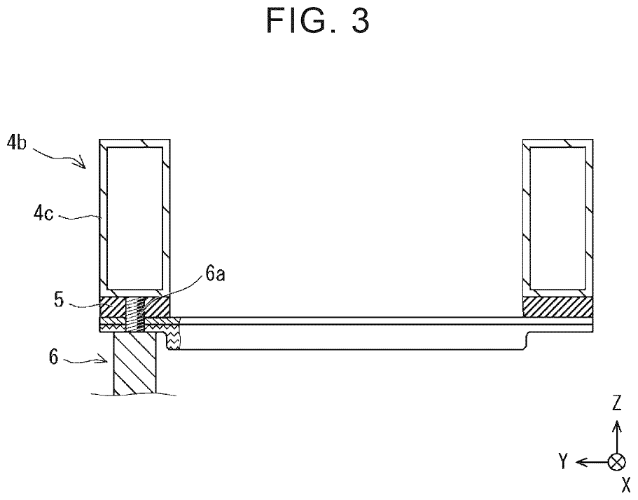

Next, a flow of manufacturing the energy storage device 1 of the present embodiment will be described. FIG. 3 is a partial cross-sectional view showing a state in which the end on the − side of the Z-axis of the frame and a peripheral edge of the cooler are joined to each other via a heat insulating member in the energy storage device of the present embodiment. First, as shown in FIG. 3, the heat insulating member 5 is disposed between the end on the − side of the Z-axis of the frame 4c and the peripheral edge of the cooler 3.

Next, as shown in FIG. 3, while rotating the tool 6, a probe 6a of the tool 6 penetrates the frame 4c, the heat insulating member 5, and the peripheral edge of the cooler 3. The end on the − side of the Z-axis of the frame 4c and the peripheral edge of the cooler 3 are joined by friction stir welding with the heat insulating member 5 interposed therebetween.

Next, when the battery module 2 is housed in the lower case 4b formed by the frame 4c and the cooler 3, and the opening on the + side of the Z-axis of the lower case 4b is covered with the upper case 4a, the energy storage device 1 can be manufactured.

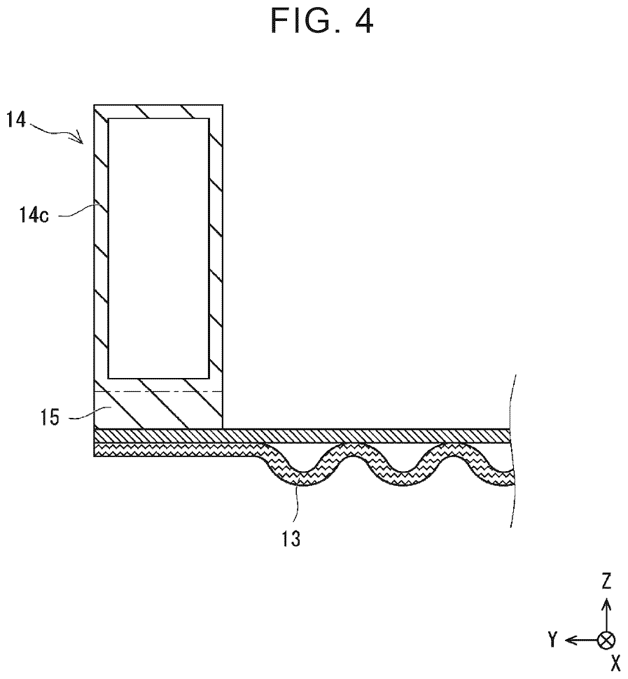

FIG. 4 is a cross-sectional view showing the arrangement relationship between the frame of the case and the cooler in the energy storage device of the comparative example. In the energy storage device of the comparative embodiment, the frame 14c forming the case 14 is made of A6061 aluminum alloy. The cooler 13 is made of A3003 aluminum alloy, and an interposed member 15 is made of A6061 aluminum alloy. The end on the − side of the Z-axis of the frame 14c and the peripheral edge of the cooler 13 are joined to each other with the interposed member 15 therebetween.

At this time, the thickness of the interposed member 15 in the Z-axis direction was set to 10 mm, and the interposed member 15 was integrally formed with the frame 14c. Then, the contact area between the frame 14c (i.e., the interposed member 15) and the cooler 13 was 1 m². The temperature of the frame 14c was set to 30° C., and the temperature of the cooler 13 was set to 10° C. The amount of heat transfer from the cooler 13 to the frame 14c was 3.6×10⁵ W.

On the other hand, in the energy storage device 1 of the embodiment, the frame 4c forming the case 4 is made of A6061 aluminum alloy. The cooler 3 is made of A3003 aluminum alloy. The heat insulating member 5 is made of A380 aluminum alloy. The end on the − side of the Z-axis of the frame 4c and the peripheral edge of the cooler 3 are joined to each other via the heat insulating member 5.

At this time, the thickness of the heat insulating member 5 in the Z-axis direction was 10 mm. Then, the contact area between the cooler 3 and the heat insulating member 5 was 1 m². The temperature of the frame 4c was set to 30° C., and the temperature of the cooler 3 was set to 10° C. The heat transfer from the cooler 3 to the frame 4c was 1.92×10⁵ W.

As described above, in the method for manufacturing the energy storage device 1 and the energy storage device 1 according to the present embodiment, the heat insulating member 5 is disposed between the frame 4c and the cooler 3 so as not to overlap the battery module 2 as viewed in the Z-axis direction. That is, cooling energy of a cooler such as a general energy storage device is transmitted to the battery module through the frame, and the battery module is not cooled. This reduces absorption of cooling energy of the cooler 3 by the frame 4c, so that the battery module 2 can be satisfactorily cooled by the cooler 3.

Further, in the method for manufacturing the energy storage device 1 and the energy storage device 1 according to the present embodiment, when the frame 4c, the heat insulating member 5, and the cooler 3 are joined by friction stir welding, they can be joined at once, and productivity can be improved. In addition, the airtightness of the joint portion can be ensured as compared with a case where the frame 4c, the heat insulating member 5, and the cooler 3 are joined by a typical weld method.

In the present embodiment, the frame 4c, the cooler 3, and the heat insulating member 5 are made of an aluminum alloy. However, the material of each member is not limited as long as the thermal conductivity of the heat insulating member 5 is lower than the thermal conductivity of the frame 4c.

Further, the frame 4c of the present embodiment has a configuration in which the − side of the Z-axis of the frame 4c is open, but may have a configuration covered with a bottom portion. In addition, the frame 4c may be configured such that the frame portion is reinforced with a reinforcement member or the like.

Further, the arrangement of the heat insulating member 5 is not limited, and the heat insulating member 5 may be disposed between the frame 4c and the cooler 3 so as not to overlap the electrical device including the battery module 2 as viewed in the Z-axis direction.

In the present embodiment, the battery module 2 is cooled by the cooler 3, but the object to be cooled by the cooler 3 may be, for example, a control device that controls the battery module 2, which is a representative example of an electrical device.

The present disclosure is not limited to the above-described embodiments, and can be appropriately modified without departing from the spirit thereof.

What is claimed is:

1. A method for manufacturing an energy storage device including a frame that houses an electrical device including a battery module, and a cooler fixed to the frame, the method comprising:
disposing a heat insulating member made of an aluminum alloy between the frame made of an aluminum alloy and the cooler made of an aluminum alloy in such a manner that the heat insulating member does not overlap the electrical device as viewed in an up-down direction of the energy storage device; and
joining the frame and the cooler with the heat insulating member interposed between the frame and the cooler,
wherein the frame, the heat insulating member, and the cooler are joined by friction stir welding.

2. An energy storage device comprising:
a frame that houses an electrical device including a battery module; and
a cooler fixed to the frame,
wherein a heat insulating member is disposed between the frame and the cooler so as not to overlap the electrical device as viewed in an up-down direction of the energy storage device.

3. The energy storage device according to claim 2, wherein:
the frame is made of an aluminum alloy; and
the heat insulating member has lower thermal conductivity than thermal conductivity of the aluminum alloy forming the frame.

4. The energy storage device according to claim 3, wherein the thermal conductivity of the heat insulating member is lower than thermal conductivity of A6061 aluminum alloy.

5. The energy storage device according to claim 2, wherein:
the frame includes a frame portion with a top and a bottom of the frame portion open;
the cooler covers a lower opening of the frame; and
the cooler and the frame form a case that houses the electrical device.
